(19) United States
(12) Patent Application Publication
(10) Pub. No.: US 2015/0350281 A1
(43) Pub. Date: Dec. 3, 2015

(54) METHODS AND DEVICES FOR CREATING A SHARED MUSIC STATION

(71) Applicant: Conversant Intellectual Property Management Incorporated, Ottawa (CA)

(72) Inventor: Robert Anthony BACON, Frisco, TX (US)

(21) Appl. No.: 14/478,882

(22) Filed: Sep. 5, 2014

Related U.S. Application Data
(60) Provisional application No. 62/006,364, filed on Jun. 2, 2014.

(51) Int. Cl. H04L 29/06

(52) U.S. Cl. CPC H04L 65/602; H04L 65/4084; H04L 65/403

(57) ABSTRACT

A method includes establishing a shared network comprising a plurality of user devices, each of the plurality of user devices containing one or more stored song files, requesting, through the shared network, a first song file from a first device among the plurality of user devices, receiving, through the shared network, the first song file from the first device, initiating playback of the first song file on a music rendering device, requesting, through the shared network, a second song file from a second device among the plurality of devices, receiving, through the shared network, the second song file from the second device, and initiating playback of the second song file on the music rendering device.

### CROSS REFERENCE TO RELATED APPLICATIONS

This patent application claims the benefit of and incorporates by reference U.S. Provisional Patent Application No. 62/006,364, which was filed on Jun. 2, 2014.

### BACKGROUND

### Technical Field

Various disclosed embodiments relate generally to shared music stations and more particularly, but not by way of limitation, to methods and devices for using a shared network to permit multiple users to share stored song files.

### History of Related Art

One way of sharing music is to take turns connecting each person's handheld device (which contains the person's music) to a stereo system or speaker docking station.

Another way of sharing music is to have one person act as the disc jockey (“DJ”) and to gather everyone's preferences. Then the DJ can play music from his or her music collection based on the requests from other group members. The DJ likely will not have access to all song files needed to fulfill all requests.

Some websites and applications let people share information on particular songs, artists, albums, etc. . . . The information can include song, artist, or album ratings. The information can also simply be information relating to which particular song a person is currently listening to. It is also possible to define an internet radio station and share the station with friends. The sharing of the radio station isn't actually sharing music though. The station sharing merely lets others listen to the type of music that someone else likes and isn't joint listening or joint creation of a shared music station. Even if a website offered others a chance to listen to another's radio station, such a feature is not much different from tuning into a radio station and listening to the radio station's playlist created by the radio station's DJ.

Generally these ways of sharing require considerable manual effort to make sure each person has a turn to share music (if at all), do not offer an easy way for the group to rate a song or veto a song, and do not let individual members of the station easily skip a song.

### SUMMARY

A method includes establishing a shared network comprising a plurality of user devices, each of the plurality of user devices containing one or more stored song files, requesting, through the shared network, a first song file from a first device among the plurality of user devices, receiving, through the shared network, the first song file from the first device, initiating playback of the first song file on a music rendering device, requesting, through the shared network, a second song file from a second device among the plurality of devices, receiving, through the shared network, the second song file from the second device, and initiating playback of the second song file on the music rendering device.

A method includes transmitting, through a communication network, a request from a user device to a host device to join a shared network comprising a plurality of user devices. receiving a user selection of a playlist of one or more songs, the one or more songs each associated with a respective song file stored on the user device, receiving, through the shared network, a first request from the host device to share one song from the playlist, identifying a first song from the playlist, and transmitting, through the shared network, a song file associated with the identified first song to the host device for playback on a music rendering device.

### BRIEF DESCRIPTION OF THE DRAWINGS

A more complete understanding of the disclosed methods and devices may be obtained by reference to the following Detailed Description when taken in conjunction with the accompanying Drawings wherein:

FIG. 1 illustrates a system for creating a shared music station;

FIG. 2 illustrates a first method of operation of a shared network;

FIG. 3 illustrates a second method of operation of a shared network; and

FIG. 4 illustrates a computer system on which various methods and devices described herein can be implemented.

### DETAILED DESCRIPTION OF ILLUSTRATIVE EMBODIMENTS

People love to share music with others as well as enjoy listening to music with others. Music can set the mood for a particular occasion along with invoking various good feelings and emotions. Some people feel that the music they listen to is even an expression of themselves. Regardless of the reason for wanting to share music with others or to listen to music with others, there are no easy ways to quickly, and generally automatically, create a shared music experience among a number of people, where each person can contribute to the group “music station,” and in which no one person or device needs to contain or consolidate all the necessary song files.

There are various embodiments for carrying out all or some of the features described herein. For example, these features can be implemented in a client/server or a peer-to-peer environment. The embodiments discussed below address some or all of deficiencies mentioned above and include numerous advantages.

In various embodiments, a truly shared and relatively automatic (i.e., without much user intervention) music station may be created from songs contributed by all members of the station such that no one person or device needs to contain or consolidate all the necessary song files. It is possible to employ principles discussed herein to other sharing opportunities such as, for example, groups of people watching YouTube videos, TV shows, or sharing photos.

A first example can take place anywhere people gather and music is a part of the experience. The following are examples of such places: gym, wedding, car ride, house party, restaurant, dance club, coffee shop, and work office.

For the sake of example, a gym (also known to some as an athletic or fitness center) is used as the setting for the following description. The stereo system for the gym will act as the host device. Each gym member's device can participate as a client. This example is described below at a high level and followed with various optional features.

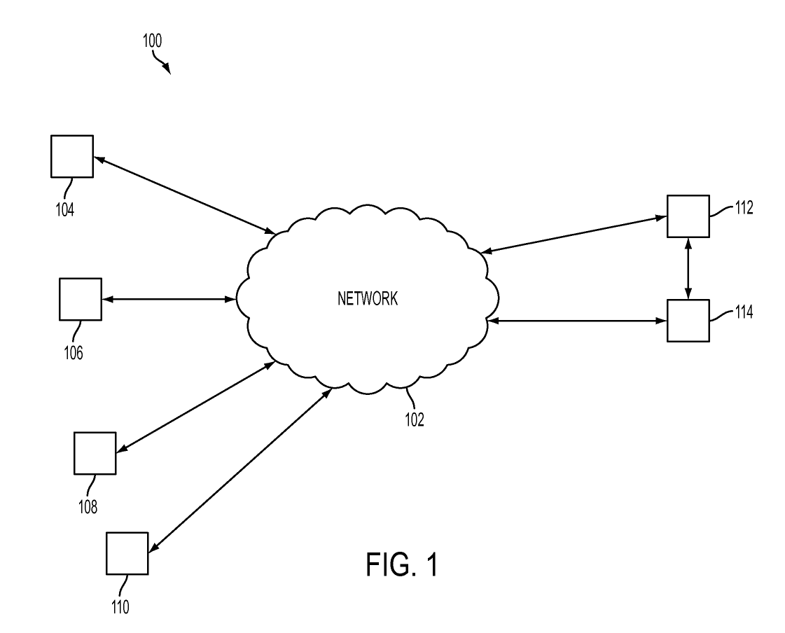

FIG. 1 illustrates a system for creating a shared music station. The system 100 includes a shared network 102, user devices 104-110, a host device 112, and a music rendering device 114. The music rendering device 114 is shown separate from host device 112 but could be incorporated into host device 112. As described below, host device 112 could be a user device dedicated as the host device.

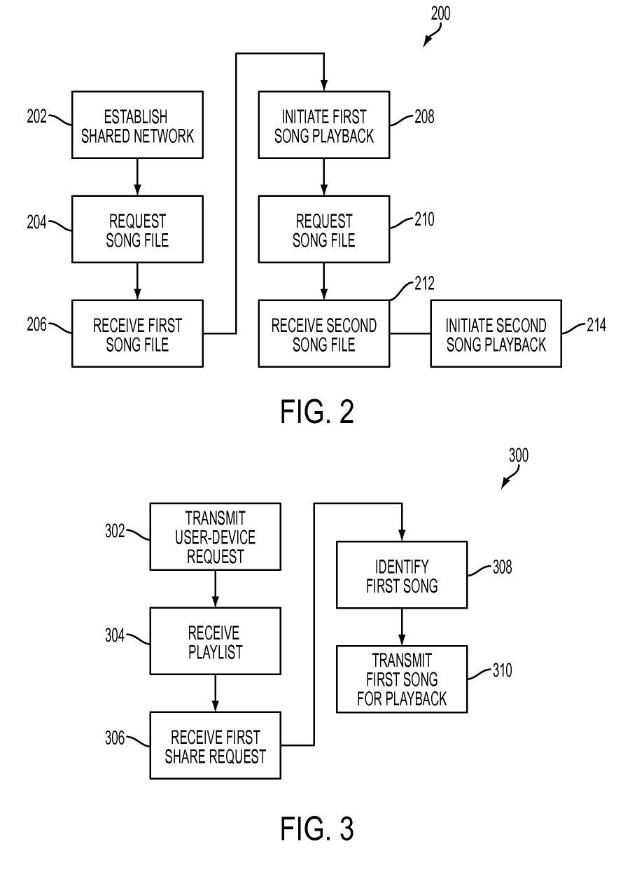

FIG. 2 illustrates a method of operation of a shared network utilizing, for example, the system 100 of FIG. 1. A method flow 200 begins at step 202. At step 202, a shared network 102, which shared network 102 includes a plurality of user devices 104-110, is established with the help of the host device 112. Each of the plurality of user devices 104-110 contains one or more stored song files. At step 204, a first song file is requested by the host device 112, through the shared network 102, from a first device (e.g. 104) among the plurality of user devices 104-110. At step 206, the first song file is received by the host device 112, through the shared network 102, from the first user device (e.g. 104). At step 208, playback of the first song file is initiated on a music rendering device 114 by the host device 112. At step 210, a second song file is requested by the host device 112, through the shared network 102, from a second user device (e.g. 106) among the plurality of devices 104-110. At step 212, the second song file is received by the host device 112, through the shared network 102, from the second user device (e.g. 106). At step 214, playback of the second song file is initiated on the music rendering device 114 by the host device 112.

FIG. 3 illustrates a method of operation of a shared network utilizing, for example, the system 100 of FIG. 1. A method flow 300 begins at step 302. At step 302, a request from a user device (e.g. 104) is transmitted, through a communication network, to a host device 112 to join the shared network 102. The shared network 102 includes a plurality of user devices 104-110. At step 304, a user selection of a playlist of one or more songs is received on the user device 104. The one or more songs are each associated with a respective song file stored on the user device 104. At step 306, a first request is received by the user device 104, through the shared network 102, from the host device 112 to share one song from the playlist. At step 308, a first song is identified from the playlist by user device 104. At step 310, a song file associated with the identified first song is transmitted by user device 104, through the shared network 102, to the host device 112 for playback on a music rendering device 114.

Users use a local application (“local app”) on their devices 104-110 to establish a playlist. The playlist can simply be identifying various song files stored on the user devices 104-110 in different folders (so no need to consolidate files) and consolidating all the song files into a particular music folder. Sub-folders can be created and playlists can be based on sub-folders. Multiple playlists can be created and a user can select any given playlist for a particular sharing opportunity. The user also has the option of selecting a music application (e.g., internet radio) for his or her playlist as well. For a music application, when the user has his or her turn, the song currently playing on the music application will be played for the group. Various features available to users are described below.

User devices 104-110 can be any type of mobile device (e.g. cell phone, netbook, laptop, PDA, mp3 player, handheld gaming device, etc.). In some scenarios (e.g. work office), the user device may be a desktop computer, smart TV, or other device that is not easily movable.

The host device 112 is responsible for registering user devices 104-110 (i.e., members) to the shared music station, requesting songs from members, and providing individual member music to other members. Additional features of the host device are described below.

The host device 112 can be any type of computing device, including, but not limited to, desktop computers, servers, mobile devices, smart TVs, and music-specific devices such as dedicated speaker docking stations.

The host device 112 and the various users' devices 104-110 can communicate with each other through a shared network 102 utilizing various wireless and wired communication technologies and protocols (e.g., Wi-Fi, Bluetooth, etc) In certain embodiments, a device can operate simultaneously as the host device and also as a client device.

When users enter the gym, they have the option of registering with the gym host device controlling the shared gym music station. The user utilizes his or her local app to facilitate registration. After initial registration, registration can occur automatically on future visits to the gym. Next, the user selects a playlist from those already created and indicated on the local app. The user can create a new playlist on the spot if he or she desires.

The gym host device 112 rotates playing music from each user device 104-110 based on user playlists and the associated songs in the playlist. The music is sent from the member user device 104-110 to the host device 112 and played through the music rendering device 114. The host device 112 keeps a record of each registered member to the music station. The host device 112 records each time a particular user has an opportunity for sharing music with others in an effort to give each registered member equal opportunity. The record may include numbers of songs shared and/or amount of music minutes shared.

The host device 112 can start by playing the own song of the host device 112 or by asking one of the user devices 104-110 for a song. Each time a user device 104-110 is asked by the host device 112, the local app automatically picks a song from the user's selected playlist. Once a song has already been shared by the local app, the local app will pick a different song for sharing next time the local app is asked by the host device 112.

The host device 112 will begin communicating with the next selected/queued user device 104-110 before the current song ends. The communication may involve letting the next user device 104-110 know that the next user device 104-110 is next in line for sharing. The communication can also include asking the next user device 104-110 to start sending an upcoming song to the host device 112 so that the host device 112 can begin buffering the upcoming song. The host device 112 may also check the upcoming song to see if the upcoming song is proper for the station (e.g., correct genre, has a high rating, length of song is appropriate, is not duplicative of a recently played song, etc. . . . ). If the song is not approved, the host device 112 may ask the queued user device 104-110 for another song proposal. For reasons described below, the host may try to buffer an entire song before beginning to play the song.

It is possible to have the user devices 104-110 send an entire song to the host device 112 for playing. Even with compressed music formats, such an approach may not be the option of choice in many scenarios. Instead, the user device 104-110 may stream its song to the host device 112 and the host device 112 will then play the song through the music-rendering system (e.g., a stereo system that includes receiver, amplifier, speakers, etc.). Alternatively, the host device 112 may give each user device 104-110 access to the stereo system of the host device 112 at the appropriate time. Then the user device 104-110 itself would send the song to the music renderer.

A user device 104-110 will eventually leave the music station network as an associated user is finished with his or her workout. Other user devices 104-110 will join as new users enter the gym for a workout.

To increase the quality of each member's listening and sharing experience, in a typical embodiment, the host and local apps function in a way that minimizes: (1) periods of silence; (2) abruptly changing songs before one song has completed; (3) inappropriate songs or lyrics for the particular experience; (4) listening to songs in duplicate; and (5) unequal sharing opportunities. Various issues are addressed in the features below.

Members of the shared music station can rate each song that is shared by other members. The rating can be, for example, on a scale of 1-5, with 5 being the best. Other rating systems are available too, such as a simple option among: like, don't like, and neutral. Users enter the rating into their respective local apps. The rating can be performed immediately upon playback of the song as well as during the song. The local app sends the rating information to the host device 112. The host device 112 receives the various ratings and can store the ratings for each song as well as for each user. The host can then utilize the ratings to influence such things as which songs are played in the future, which songs should end early, and how often particular members have an opportunity to share. See the examples below for more details.

Generally, there is no reason to allow a song to complete if, for example, a majority (or preset number of users) does not like the current song playing. If a majority or preset number of users rates the song low, the particular song can be immediately ended—or at least as soon as the host device 112 schedules and prepares the next song. The host device 112 could also use one of the default songs of the host device 112 while preparing the next song in order to end the current song that the majority of members do not like.

In some embodiments, the local app may include a selectable “Skip” feature. The “Skip” feature is at least equivalent to giving the song a low rating. The same principle applies with the skip feature. If a majority or preset number of users hit the skip button, the particular song can be ended and the host device 112 will make appropriate records of the skipped song and record the identity of the user who proposed the song as described in more detail below.

Users who receive higher ratings for their music selections may have increased frequency for playing their songs on the shared station. Likewise, users whose songs are skipped or that receive low ratings may have decreased frequency to play songs on the shared station. Users will also receive a lower rating if there are issues with the user's ability to share music effectively. The issues may, for example, be related to poor streaming quality, low data rate, or issues related to the user's device dropping off the shared music station network (e.g., battery dies on the user device 104-110, the device is powered off, or the user shuts down the app before a song finishes).

In many cases, the host device 112 may try to buffer an entire song or most of the song before playing the song in an effort to decrease the chance that the song has to be cut short because song data is not available for the reasons mentioned above or any other reasons. Sometimes while trying to buffer the host will lose connection or otherwise not receive any more music data from a particular user. The particular user's rating may be adjusted accordingly in such situations. If the user's rating falls below a preset threshold (e.g., two incomplete music buffering sessions), the user may no longer have an opportunity to share music or at least may be suspended from sharing for a predetermined period of time.

If the host does not have enough time to request a song from another user under the failed buffering example above, the host may default to its own stored song or a previous stored song from a member. Ideally, the replacement song will meet the requirements of the shared station as best as possible (e.g. genre, tempo, rating, etc.). Nevertheless, a default song will be better than silence on the station in most scenarios.

In some embodiments, there may not be a buffer created in a host system or in a music renderer. In these embodiments, the user device 104-110 may stream on a “live” basis. The quality of experience is directly tied to the user device 104-110 completing the streaming of the song in an appropriate manner. The user's local app may minimize or eliminate the user's ability to change the currently playing song. Otherwise, a particular user could keep control of the station by never letting a song complete and switching to a new song. For whatever reason a song is cut short, the user's rating could be marked lower. To the extent the host device 112 can detect the song being cut short, the host device 112 can itself lower a user's rating. Alternatively, the other members can use the local app to indicate that a previous song was cut short. If enough users indicate that a previous song was cut short, the host device 112 can make an appropriate change to the user's rating.

When the host device 112 communicates with the next queued user device 104-110, the host device 112 can request the song title. Alternatively the host device 112 can check the song title from the song metadata when the queued device begins streaming the song to the host device 112. Either way, the host device 112 can check the database of song ratings of the host device 112 to see if the next proposed song has sufficiently low ratings. If yes, the host device 112 can alert the queued user device 104-110 to stop streaming the upcoming song and to select another song. The local app will select the next song in the user's playlist and begin communicating with the host device 112 related to the new song. In the meantime, the local app can alert the user via a display on the user device 104-110 that a particular song was rejected on the shared music station due to low ratings.

Similar to the Song Ratings feature, the host device 112 can compare the proposed upcoming song to a record of previously played songs. The host device 112 can reject a proposed song if the song has already been played within a particular time period (e.g., within the last 60 minutes).

As an alternative, the host device 112 can take a sample (particularly the beginning) of each song played and of the proposed upcoming song. The host device 112 can then compare the samples to identify duplicate songs. The comparison can include comparing detected words and tempo (e.g., BPM). The sample analysis could be used in conjunction with comparing metadata since metadata can be incorrect. If a duplicate song is detected, the system prompts the local app of the user device 104-110 to select a new song from the queue and transmit the new song to the system.

In one embodiment, the queued user device 104-110 sends multiple songs for the host device 112 to approve. If the first song is suitable for playback, the first song is selected and the host device 112 alerts the queued user device 104-110 to stream or otherwise transfer the first song. If the first song is a duplicate, or is not suitable for playback for other reasons, the host device 112 can request the second song.

In certain embodiments, the host device 112 may identify, and if needed, detect various attributes about the current song and next proposed/queued song. Many song attributes can be found in the song's metadata, which metadata is available in common popular music-file formats. The metadata may include attributes such as the song title, artist, album, speed, genre, start-time, and end-time. New metadata protocols continually expand the metadata available for songs. Song attributes may be detected by the host device 112 particularly if the metadata is not available.

If partial metadata is available, like song title, the host device 112 may search various databases for other metadata related to that song (e.g., start-time and end-time). The host device 112 could reject a proposed song that does not have the proper metadata and ask the user device 104-110 for another song proposal. For rejected songs, the host device 112 may give the reason why so that the local app can alert the member to update the song metadata or get a new copy.

Detecting silence is a beneficial feature of the host device 112. The silence could mean that the current song has ended or that the current song was cut short. Either way, the host device 112 would want to minimize the silence. Regarding the song end time, the song end-time information is typically available in the song metadata. The host device 112 may attempt to synchronize the ending of one song with the beginning of play of the next song. Since metadata can be incorrect and even modified by users, the host device 112 may use its own silence detection along with the available metadata.

The host device 112 can in some embodiments also detect inappropriate lyrics. When a station is configured, the station can have a rating. Certain ratings would eliminate the use of common profanity. The host device 112 can take samples of a song as the song plays and compare the detected words to a list of excluded words. The host device 112 could analyze each word of the song but, in a typical embodiment, samples would likely be sufficient. If profanity is detected, the song could be cut short. If song-rating metadata is available, the song rating metadata may be utilized as well.

The host device 112 can also detect if a voice memo is playing versus a music song. Mobile devices, for example, commonly have voice-memo recording features. Generally people do not want to listen to others' voice memos. If a voice memo is detected, the voice memo could be cut short. The voice memo can be detected based at least partially on tempo detection (e.g., BPM) and the detected tempo being below a preset threshold.

In similar fashion to voice-memo detection, the host device 112 may also detect commercial advertisements. The most likely scenario for commercial advertisements would be if a particular user selected a music application (e.g. internet radio) as his or her playlist. If a commercial advertisement is detected, the commercial advertisement could be cut short. The commercial advertisement can be detected based at least partially on tempo detection (e.g., BPM) and the detected tempo being below a preset threshold.

Upon detecting a song cut short, inappropriate lyrics, a voice memo, or a commercial advertisement, the host device 112 can make a record under the offending user device 104-110 and also lower the rating of the offending user. Frequent offenders could eventually be removed from all sharing opportunities or at least be suspended for a predetermined time period (e.g., two hours).

The shared-station membership may be based on location. Various location-detection methods are available to the host device 112 (e.g., Bluetooth detection or GPS-based detection). It may be beneficial to limit the shared station to only individuals at a particular location: a particular gym, office, house, coffee shop, or vehicle. One reason is to limit the influence (e.g., rating of songs or choice of music) of others who are not part of the immediate group and may not share the same music interests of a particular group. The host device 112 may be configured to limit station membership based on location.

It is possible to limit a shared station to more than one physical location. For example, coworkers in two locations (e.g., Plano, Tex., and Ottawa, Calif.) or families in different countries may share a station. The GPS detection, for example, can allow members from multiple accepted locations to join the shared station. In such scenarios, appropriate technologies could be utilized to allow either playback from a music rendering device 114 at each location or directly to each member's own personal device. One option is to utilize a music server available through the internet at a particular IP address. As long as each device has an internet connection, they could register, share music, and listen to other member's music on the shared station. Alternatively, each location could be connected to each other through local hosts who coordinate between the locations. The members at each location could use short-range or local wireless technology to connect with each local host device 112.

Once a playlist is created, the playlist can be identified to be a default playlist for the user for a particular shared music station. Because shared music station names may change from time-to-time, the playlist can be identified as the default playlist for a particular location (GPS) or even IP address.

When a user device 104-110 registers with the host device 112, the host device 112 will query the user device 104-110 for particular user settings. One of the settings relates to the mode of sharing the user has selected. The modes can be any of the following: sharing and listening; sharing only; and listening only.

If the user has selected a mode that includes sharing, the host device 112 will request a song from the user device 104-110 when it is the user's turn. The user has an option to share only. The share-only mode allows the user to contribute to the shared station without even listening to the station. Some users may choose to listen only to their own music. However, such users may not mind sharing their music with others. The user's device will receive a notification for an upcoming share opportunity. The user's device automatically (without the user's intervention) responds to the request of the host device 112.

Conversely, some may users choose to only listen in on the shared station but not contribute to the station. These users may still be permitted to participate in the rating system.

Sometimes instead of a shared music rendering device 114, it may be beneficial for a user to receive the shared music station directly on his or her personal device. The host device 112 can make individual device reception in lieu of, or in addition to, playing the shared music on the music renderer. The option of music renderer may be configurable for each member device.

In the gym example, the gym host can broadcast the shared music station to make the shared music station available for individual device reception. The broadcasting can occur through various known technologies. For example, the host device 112 could make the station available through a local music server on the gym intranet, as well as utilize any known multicasting or broadcasting technologies and associated protocols. Many environments (e.g. gym, work office, coffee shop) will offer free Wi-Fi access to the internet or intranet. User devices 104-110 are often Wi-Fi enabled. Consequently, a host device 112 can provide individual device reception fairly easily.

In different embodiments, such as a car ride with several family members, the broadcast could use Bluetooth piconet protocols to share with other devices in the car as well as the car's music renderer. Individual device reception allows users to listen to music with headphones. That way a user can control the volume of the music as well as take advantage of other features like the Individual Skip Feature below.

If a user doesn't like the current song being played on the shared music station, the user may utilize the local app to skip that song and their own song will play for them on their device. When the current shared station song ends and a new one begins, the local app can alert the user. The local app may allow the user to select between various settings. In one setting the local app may automatically pause the user's personal song and play the next shared station song. The user can skip the new song again and continue listening to the current personal song. Another setting may visually and/or with an audible noise alert the user that a new song is playing on the shared station. The user can then elect to switch to the new song or continue listening to their personal song.

Users can also select a feature on the local app to temporarily skip all turns for sharing music. With the temporary-skip feature enabled, the local app would decline a request from the host device 112 to play a song if the host device 112 sends the request. Alternatively, the local app may communicate with the host device 112 and change the mode settings of the user device 104-110 to listen only mode, no sharing. When the user disables the temporary skip feature, the local app may communicate with the host device 112 to change modes back to sharing.

The host device 112 may be configured to play its own copy of a proposed song if the host device 112 has the copy or can quickly retrieve the its own copy. One benefit of this feature is that there is less chance that the song will be cut short because of a user device 104-110 running out of power, being shut down, or because of communication difficulties. Another benefit is that the quality of the song will likely be better if played from the copy of the host device 112 versus being streamed by the user device 104-110. A user device 104-110 sending song data to a host device 112 could be of slightly lower quality to save bandwidth or because of communication interference.

The host device 112 may use the proposed song's metadata to learn the title and artist information. Alternatively, the host device 112 can request the song and artist information from the user device 104-110. The local app can be configured to require the user to enter song and artist information for any song that does not have appropriate metadata. Then the local app can share this entered information with the host device 112. Another option is for the host device 112 to sample a portion of each song (e.g., the first 20 seconds) that the host device 112 has in a host-device music database. The host device 112 can then sample the proposed song and compare the sample to a its music database while looking for a match. Regardless the technique, if the host device 112 has a copy of the song, the host device 112 can then play the song.

When the host device 112 plays its own song, the host device 112 will alert the user device 104-110 so that the user device 104-110 does not itself try to transfer the song to the host device 112 or music renderer. The local app of the user device 104-110 (as well as other member's local apps) can display a note to the user that the copy of the song is from the host device 112. The user (and possibly other members) can rate the quality of the host's copy. Via this quality rating, the host could be alerted that the host has a poor quality copy of a particular song and a particular user's ratings should not be downgraded because of the poor quality. The host device 112 can try to retrieve another copy of the song or at least not play its own copy the next time the song is proposed to be played by a member.

If a user chooses a music application (e.g., internet radio) as his or her playlist, this feature could also be beneficial. The host device 112 would still try to receive song metadata or user-entered metadata for the particular proposed song. The host device 112 could also use song sample detection to identify the title and artist. However song determination occurs, the host device 112 could play its own copy if available. Doing so minimizes the timing and coordination issues that can occur with playing a song from a music application that is controlled by a third party. At times the host device 112 may only be able to determine the song title and not the particular artist. In such cases the host device 112 may choose any copy of the proposed song even if from another artist. If the host device 112 has the same song from multiple artists, the host device 112 could, for example, look to station member ratings for each version and then play the highest-rated version.

The host device 112 may have its own memory storage system of song files located with the host device 112 or from a remotely accessible storage system. Some host devices 112 may have the option of retrieving new songs from various available internet music stores. Even if the host device 112 cannot retrieve its own copy of a proposed song in time to play the song next, the host device 112 may in some embodiments nevertheless acquire a copy for the next time the song is proposed.

In some embodiments, the user can utilize his or her local app to select a music application as his or her playlist. In other words, the user does not list particular songs in a playlist and may not have a local copy of the song file. Instead, the user would like to have the music application's song play when it is their turn to share—whatever the song may be at that time.

For an example, consider typical internet radio stations as the music application selected. Internet radio stations may allow a user to influence the station music selected but not select particular songs. Alternatively, a user may only be able to select a station dedicated to playing a particular genre or type of music. Internet radio stations generally stream music to a user device 104-110 and some provide song metadata with the music data. Internet radio stations generally also allow the user to pause the playback of a song. Some internet radio stations let the user skip the current song and move to another song on the internet radio station.

It is generally not beneficial to switch to a queued user device 104-110 that selected a music application and have a song start playing from some other point in the song than the beginning. In particular embodiments, the local app may only allow the user to select a music application with a pause feature. The pause feature will help facilitate timing and coordination on the shared station and facilitate playback of a song from the beginning. In these embodiments, the host device 112 could notify the next queued user device 104-110 and request a song. The queued device will likely be already playing a song from the internet radio. If song metadata is available for the internet song, the queued device checks the metadata to see when the current song will end. If the current song will end within a predetermined time period allowed by the host (e.g., one minute), the queued device will let the current song end and pause the new song when the song begins. As described in other embodiments, the queued device may send the new song's metadata to the host device 112 for approval or a sample of the new song.

If approved, the queued device may then begin playing the new song and send the new song to the host device 112 for buffering as previously described. If the new song is not approved by the host device 112 (e.g. the new song is a duplicate), the queued device will be notified and have a chance to submit a new song. If the particular internet radio station allows song skipping the queued device can try to skip the new song and begin the approval process with the next song. If skipping is not allowed, or the time period for submitting a proposed song has run out, the local app will notify the host device 112 to skip the particular user for that turn.

In some instances, the current song will not end within the predetermined time period allowed by the host (e.g., one minute). In these cases, the queued device may skip the current song and pause the new song when the new song begins. If skipping is not allowed, the local app may notify the host device 112 to skip the particular user's turn.

In some other instances, the metadata will not be available to the queued device and the queued device will not be able to determine when the current song ends. In these cases, the queued device will be given a predetermined amount of time (e.g., 40 seconds) to detect the end of the current song. If the current song ends, the new song will be paused and the approval process will begin with the host device 112. The song may be paused after playing the song for a short period (e.g., 10 seconds) so that a sample can be sent to the host device 112 for approval. If approved, the song is played, sent to the host device 112, and buffered as previously described. In other cases, the queued user device 104-110 will not wait to see if the current song ends but instead will utilize the skip feature if the skip feature is available. If the skip feature is not available or the song ending is not detected within a predetermined time period, the queued device will ask to skip the queued device's turn.

In certain embodiments, the pause feature may not be available for the particular music application. In these circumstances, the queued device may rely on the skip feature if available. When the new song starts playing, after the previous song is skipped, the queued user device 104-110 sends a sample of the new song to the host device 112 for approval while buffering the song. Alternatively, the host device 112 can receive the entire stream from the queued user device 104-110, and if the song is approved, the buffering process will have already started. If not approved, the host device 112 erases the buffered music and notifies the queued user device 104-110 that the song was not approved. As an alternative to the skip feature, the queued user device 104-110 may also use the end of song detection within a predetermined time period. If the song ends, the new song can be locally buffered while waiting approval or be sent to the host device 112 for buffering and approval.

As previously described, the host device 112 can detect commercial advertisements that can occur on internet radio stations. Commercial advertisements will not be approved and if they occur in the middle of a song, the song will be cut short.

In general, selecting a music application as the playlist by one or more station members does not change the functionality much, if at all, of the various features and embodiments described herein, nor does the selecting change much, if at all, the interaction between various devices.

The shared station can be configured to prioritize particular users and their associated playlists. As a result, the prioritized users will receive more opportunities to share on the station. For example, a shared station at a wedding may prioritize the bride and groom. A shared station in a car may prioritize the car owner. The prioritization can also occur through the rating system. In the rating system, users with higher rated songs may receive priority.

The shared station can be configured in various ways. For example, it can be configured to only play a particular genre of music or multiple selected genres. The host device 112 may utilize the queued song metadata to determine if the proposed song meets station configuration criteria. If the song does not, the song will not be approved and the particular user device 104-110 may be permitted to propose another song.

Another option for the station is tempo variety. The tempo can be set so that the host mixes songs with slow, medium, and high tempos. Alternatively, the tempo can be set to a specific range (e.g. high tempos). For example, a gym shared station may be set to play only songs having a tempo exceeding a particular threshold in an effort to keep the energy high for working out. Other situations may be best suited with the tempo set for variety. For example, at a dance club people tend to like a variety of fast dance songs mixed with slow songs.

The host device 112 can utilize the song metadata to determine tempo. Some metadata may not include the song's BPM but instead have a “speed” category of slow, medium, fast, and hardcore. Either way, the tempo or indication of tempo is not always available as song metadata. If tempo metadata is not available, the host device 112 can detect the song tempo. The host device 112 can measure the beats per minute of all songs played and keep a record as needed to carry out the tempo selection. The host device 112 will detect the queued song's tempo and if the tempo is not appropriate, the host device 112 may request a new proposal for the next song. The various station options (e.g. genre, tempo, membership criteria, etc.) can be set with the music-station creation and updated as needed.

In particular embodiments there may be more than one shared station available at a particular location (e.g., home, office, gym, etc.). For example, in a house there might be one station labelled “kids” and another labelled “adults.” Stations could also be based on music genres (e.g., blues, country, etc.).

Users have the option of creating playlists with songs prioritized in an effort to guide the local app when sharing.

It is possible that there will be times no members want to share music on the shared station. In such cases, the host device 112 may play its own playlist until one of the members wants to share. The default music can also be useful for other scenarios mentioned previously (e.g., music is cut short or the time for proposing songs runs out).

In some embodiments, the members' user devices 104-110 will have direct access to the music renderer. The host device 112 may generate a particular password for each upcoming opportunity. The password can be shared with the music renderer. The music renderer would then only accept music from the user device 104-110 with the appropriate password. Alternatively, each user device 104-110 may be given a password when the user device 104-110 joins the network. The host device 112 will provide a queue for the music renderer. The music renderer would only accept music from the user device 104-110 that has the password and is currently playing a song, and possibly the next queued device if the music renderer will buffer the upcoming song.

It is also possible to function without passwords. In general, the host device 112 coordinates when a particular user device 104-110 is scheduled to send the music of a particular user device 104-110 to the music renderer.

In certain embodiments, a device can operate as the host device 112 as well as a client device. For example, a user may establish a shared music station and dedicate his or her device as the host device 112. The user's device then fulfills the various host-device responsibilities using the host app. At the same time, the user can have the client local app running simultaneously. The user would use the client local app to select a playlist and to participate as station members typically participate. The host app and the client app can be integrated so that any device can easily be configured as the host, client, or both.

In certain embodiments, no songs are sent from user devices 104-110 to a host device 112 or music renderer. Playlists are still shared and many of the foregoing features are still applicable. For sake of example, a wedding will be described as the setting for the following description.

The wedding DJ has equipment that acts as the host device 112. The wedding party and the wedding guests (together music-station members) utilize their mobile devices as clients and join the shared station. The members still create playlists or choose existing playlists as described previously. In this embodiment, music metadata is shared with the host device 112. In particular, the host device 112 may receive a proposed song title and related artist information. The host device 112 checks for duplicates and generally operates as in other embodiments. The host device 112 tries to retrieve the proposed song from its own music storage system or third party music systems. If a proposed song cannot be retrieved, the queued user device 104-110 is notified and may be given a chance to propose another song. If no other song is proposed, the host device 112 can move on to another member.

As songs play, the station members may rate songs as described before and priority users can be set (e.g., bride and groom may be given more priority). Playlists may be created for different time periods of the wedding (e.g., dinner music v. dancing music). Tempo detection can be useful to keep dinner music to appropriate low-tempo songs.

In some embodiments the host device 112 may let the queued user device 104-110 send a sample of the proposed song to the host device 112. The host device 112 can then try to compare the sample to its own database of samples as described previously in order to find a match.

In certain embodiments, it may be beneficial to operate in more of a peer-to-peer (P2P) fashion than host/client fashion. Many of the features described above are equally applicable without much or any modification.

For the sake of example, a car ride is described as the setting for the following description. The car ride could be taken by a family or group of friends on a long road trip or even a relatively short trip to a store or restaurant. In any case, a number of people (i.e., members) will have a user device 104-110 with which to contribute to the shared music station. Each member will utilize the local app on his or her user device 104-110 to join the shared station, to create or select a playlist, rate songs, etc. as discussed above.

The shared station may be created by one member and then others can join. The creating member may also configure the initial settings of the station. Other members may be allowed to update the settings once they join the shared station.

The shared station may be set so that each one of the member devices is also the music renderer during that associated member's turn to share. Alternatively, one or more devices can be selected as the music renderer (e.g., the radio system in the vehicle) for the station. It is also possible to allow members to pick their own music renderer during their turn to share. Under this scenario, some users may pick the vehicle radio system, some may pick their own device, and some may even pick other members' devices. Generally, each device would have a direct line of communication to the music renderer of choice. However, it is possible to have some members utilize other members' devices as a pass-through to the music renderer of choice.

In some of the P2P embodiments, “control” of the current station song rotates among station members. In one embodiment, a token is passed to the user device 104-110 in control of the station. The token may include the password to the music renderer. The user device 104-110 currently in control can notify the next user device 104-110 that the turn of the next of the user devices 104-110 is coming so the next user device 104-110 can make any necessary preparations. The token can be passed after the current song completes or as it is completing in order to make a smooth transition between songs. It is also possible for the token to pass before the song completes and for the queued user device 104-110 to wait for a notification from the current user device 104-110 that the current song has ended. The queued user device 104-110 can also utilize silence detection to determine if the current song has ended.

In certain embodiments, it may be beneficial to update the token password on a regular basis or even with each user device 104-110 as the user device 104-110 takes its turn. This way, old token passwords cannot be used and there is less likely a chance for multiple user devices 104-110 simultaneously competing for the music renderer. The most conservative approach is to have the user device 104-110 currently playing a song to update the token password with the music renderer. Then, except for transitions between user devices 104-110, only one user device 104-110 can play through the music renderer at any given point in time. The music renderer may have an associated local app that will only accept music from the user device 104-110 that knows the current password.

If the current user device 104-110 with control detects a period of silence, the current user device 104-110 may assume that the current user device 104-110 is having difficulty transmitting music to the music renderer. Upon detection, the current user device 104-110 may send the token to the next queued user device 104-110. If a period of silence lasts beyond a predefined threshold, the local app on one or more user devices 104-110 may notify their respective user and prompt the user to see if a new shared station should be created.

In certain embodiments, a dedicated user device 104-110 may be utilized to record song ratings, vetting proposed songs for such things as checking for duplicates, and generally carry out the features listed in the other examples. The device creating the shared station would be the default dedicated device. This device would also allocate opportunities for sharing similarly to what has been described above. Other member devices can assume the “dedicated device” position as needed.

In other embodiments, modified versions of the features above could be implemented without having a dedicated device. The following are some examples. The user device 104-110 currently in control of the shared station could receive ratings feedback from other members. The local app on this user device 104-110 would consolidate the ratings. The local app could use this information to reduce the frequency of a particular song being selected in the future, or increase the frequency of a highly rated song. The feedback could also include the majority skip feature. The local app would determine if a predetermined threshold of members want to skip the song. If the threshold is reached or passed, the local app of the user device 104-110 in control could end the song and pass the token to the next user device 104-110.

In the embodiments, without a dedicated device, the token-passing sequence may be initially defined by the device that created the shared station. The creating device would register members and provide information to each member device to which they are to pass the token. As members leave or join, the initiating device will update the sharing information to the other members. Alternatively, each member device will have a list of all other member devices. Passing of the token can be randomly performed. The random token passing will generally spread the opportunities to all members. Some embodiments may include weights to the random algorithm. The weights may be based on ratings. As a particular member rates other members' songs, the rating (“local rating”) is stored in the particular member's device via the local app. The local rating may be used as a weight to influence the randomness. Members with higher ratings will have more probability of being selected in the random process.

Conversely, members with lower ratings will have less probability of being selected. With either random process, members can easily leave and join without presenting a burden on the system. Members that leave are taken off of each list in the members devices and new members are added.

The random with weights token passing is one way of allocating sharing opportunities to those members who have the highest ratings. It is possible for a local app to ban the local app's member from sharing if the user reaches a threshold level of low ratings or majority skip occurrences. In this scenario, the local app would simply pass the token to the next device instead of taking a turn. After a predetermined time period, optionally coupled with the user selecting or creating a new playlist, the local app would then allow the user to have a turn instead of immediately passing the token.

Without a dedicated device to check for duplicates, each user device 104-110 can try to avoid duplicate songs itself. The local app of each user device 104-110 can share song metadata of the playing song with the other members. The other user devices 104-110 can store the song metadata (e.g., song title and artist). Each local app would then compare the local app's proposed song against the local app's own list of previously played songs and remove song proposals that are duplicates. Songs may be removed from the duplicate list after a predetermined time period (e.g., two hours).

Alternatively, each user device 104-110 can sample (e.g., using its microphone) the current song being played and then add the sample to the local device's storage of songs played within a predetermined time period. The local app can compare the proposed song to the previously stored samples. If there is a match, the song is skipped and a new song proposed.

In particular embodiments, it may be desirable for one or more of the station members to listen to the shared music station from their own user device 104-110 and even with headphones. In such cases, the dedicated music renderer can be set to broadcast, or otherwise make available, the station to each member's user device 104-110. In some embodiments, there can be multiple chosen music renderers (as described above) and each one may have the capability to broadcast, or otherwise make available, the station to each member's user device 104-110. The Individual Music Skip feature may be more beneficial when coupled to the embodiments that facilitate members listening on their own devices.

Many songs are protected by various copyright laws. Some of these songs are dedicated to the public by the copyright holder, while others require paying the copyright holder one or more royalties in order to listen to the song or play the song for others.

In certain embodiments, the host device 112 tracks the shared station songs that are played, how many members listened to the song, and in certain circumstances, how the song was shared (e.g., sent to individual devices vs. played on one music renderer for all members). The host device 112 can use the song metadata to identify songs for royalty accounting purposes. In some embodiments, the host device 112 may reject any proposed song that does not have the metadata or otherwise have the appropriate song information to track songs for royalty accounting. The host device 112 can consolidate the royalty information and report that information to the appropriate third party.

In other embodiments, the members' user devices 104-110 track the songs played on their respective devices and then report back to the host device 112. The host device 112 can consolidate the royalty accounting information.

In certain embodiments, each member device is responsible for tracking and reporting royalty information to a third party. In such cases, the song metadata, or other relevant information, is shared with or made available to each device.

The host and client apps may be configured to prevent the use of the particular app until a connection is made to the appropriate third party so royalty tracking information can be shared. They can also be configured to allow the particular app to be used for a predetermined duration even if a connection to the third party cannot be established. The predetermined duration may be based on a particular number of songs played and/or a particular duration of music played. Once the predetermined duration is met or exceeded, the app will not function (or with only limited capabilities) until a connection is made to the third party. The connection may simply be uploading data to a website, sending an email to the third party, or even sending a SMS or MMS message to a third party. In some embodiments, the third party will send an acknowledgement or authorization to the host or client app that the host or client app can proceed with full functionality again.

In some embodiments, the host device 112 will be responsible for paying the royalties owed. The owner of the host device 112 may subscribe to a monthly service and/or allow sponsors to pay the royalties. The sponsors may require advertisements on the host device 112 and/or member devices in return for paying the royalties. In other embodiments, the members are responsible for paying the royalties owed. Similar to the host owner, the members can pay the amounts owed, subscribe to a monthly service, and/or allow sponsors to pay the royalties in return for advertisements on the member device or something else.

In addition, or as an alternative, sponsors may utilize poll questions in exchange for paying the royalties owed. Periodically the local app could present poll questions from a sponsor to the user of the device. In order for the user to continue using the local app, the user would need to respond to the one or more poll questions. The local app sends the user responses to the poll questions either direct to the sponsor or to a third party that consolidates the poll responses. In some embodiments the user can delay answering poll questions.

Once the user has reached his or her delay maximum, the user has to answer all accumulated poll questions to continue using the full functionality of the local app and consequently the shared music station. A similar solution may be utilized for watching advertisements from sponsors. The local app would not let the user end the advertisement. One or more poll questions could be presented to the user after the advertisement. In some embodiments particular user devices 104-110 may be in share only mode. In such cases the users who are not listening to another member's song would not be counted for royalty sharing.

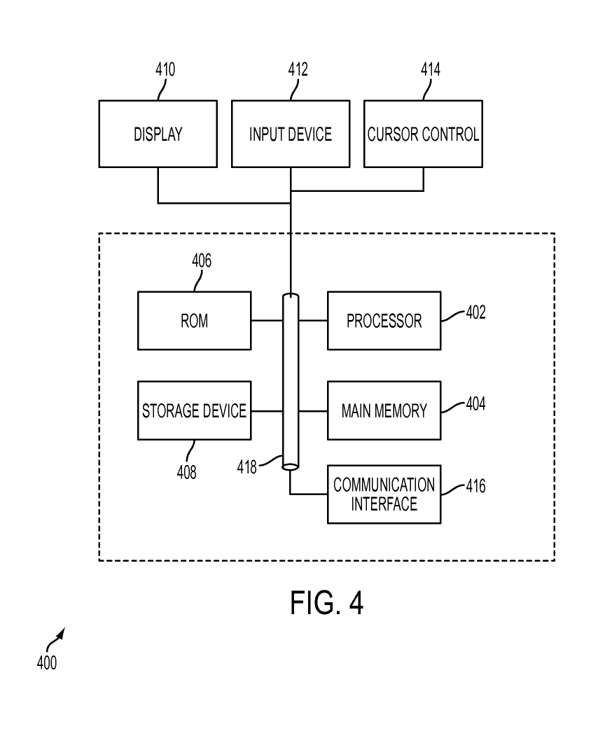

FIG. 4 illustrates a computer system 400 on which various methods and devices described herein can be implemented. For example, the computer system 400 can be illustrative of a host device 112 of a shared network 102 or of or more user devices 104-110.

The computer system 400 may be a physical system, virtual system, or a combination of both physical and virtual systems. In the implementation, a computer system 400 may include a bus 418 or other communication mechanism for communicating information and one or more processors 402 coupled to the bus 418 for processing information. The computer system 400 also includes a main memory 404, such as random-access memory (RAM) or other dynamic storage device, coupled to the bus 418 for storing computer readable instructions by the one or more processors 402. The computer 400 may have coupled thereto devices for wireless communication according to various standards, including, but not limited to, various cellular-telephone standards and short-range wireless standards such as BLUETOOTH, WIMAX, and WIFI.

The main memory 404 also may be used for storing temporary variables or other intermediate information during execution of the instructions to be executed by the one or more processors 402. The computer system 400 further includes a read-only memory (ROM) 406 or other static storage device coupled to the bus 418 for storing static information and instructions for the one or more processors 402. A computer-readable storage device 408, such as a magnetic disk or optical disk, is coupled to the bus 418 for storing information and instructions for the one or more processors 402. The computer system 400 may be coupled via the bus 418 to a display 410, such as a liquid crystal display (LCD) or a cathode ray tube (CRT), for displaying information to a user. An input device 412, including, for example, alphanumeric and other keys, is coupled to the bus 418 for communicating information and command selections to the one or more processors 402. Another type of user input device is a cursor control 414, such as a mouse, a trackball, or cursor direction keys for communicating direct information and command selections to the one or more processors 402 and for controlling cursor movement on the display 410. The cursor control 414 typically has two degrees of freedom in two axes, a first axis (e.g., x) and a second axis (e.g., y), that allow the device to specify positions in a plane.

The term “computer readable instructions” as used above refers to any instructions that may be performed by the one or more processors 402 and/or other component of the computer system 400 to implement, for example, the processes described in FIGS. 2-3. Similarly, the term “computer readable medium” refers to any non-transitory storage medium that may be used to store the computer readable instructions. Such a medium may take many forms, including, but not limited to, nonvolatile media, and volatile media. Non-volatile media include, for example, optical or magnetic disks, such as the storage device 408. Volatile media includes dynamic memory, such as the main memory 404. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

Various forms of the computer readable media may be involved in carrying one or more sequences of one or more instructions to the one or more processors 402 for execution. For example, the instructions may initially be borne on a magnetic disk of a remote computer. The remote computer can load the instructions into its dynamic memory and send the instructions over a telephone line using a modem. A modem local to the computer system 400 can receive the data on the telephone line and use an infrared transmitter to convert the data to an infrared signal. An infrared detector coupled to the bus 418 can receive the data carried in the infrared signal and place the data on the bus 418. The bus 418 carries the data to the main memory 404, from which the one or more processors 402 retrieve and executes the instructions. The instructions received by the main memory 404 may optionally be stored on the storage device 308 either before or after execution by the one or more processors 402.

The computer system 400 may also include a communication interface 416 coupled to the bus 418. The communication interface 416 provides a two-way data communication coupling between the computer system 400 and a network. For example, the communication interface 416 may be an integrated services digital network (ISDN) card or a modem used to provide a data communication connection to a corresponding type of telephone line. As another example, the communication interface 416 may be a local area network (LAN) card used to provide a data communication connection to a compatible LAN. Wireless links may also be implemented. In any such implementation, the communication interface 416 sends, via one or more transmitters, and receives, via one or more receivers, electrical, electromagnetic, optical, or other signals that carry digital data streams representing various types of information. The storage device 408 can further include instructions for carrying out various processes for image processing as described herein when executed by the one or more processors 402. The storage device 408 can further include a database for storing data relative to same.

Depending on the embodiment, certain acts, events, or functions described herein can be performed in a different sequence, can be added, merged, or left out altogether (e.g., not all described acts or events are necessary). Moreover, in certain embodiments, acts or events can be performed concurrently, e.g., through multi-threaded processing, interrupt processing, or multiple processors or processor cores or on other parallel architectures, rather than sequentially. Although certain tasks may be described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements, or states are in any way required for one or more embodiments or that one or more embodiments necessarily include logic for deciding, with or without author input or prompting, whether these features, elements, or states are included or are to be performed in any particular embodiment.

While the above detailed description has shown, described, and pointed out exemplary features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method comprising:
establishing a shared network comprising a plurality of user devices, each of the plurality of user devices containing one or more stored song files;
requesting, through the shared network, a first song file from a first device among the plurality of user devices;
receiving, through the shared network, the first song file from the first device;
initiating playback of the first song file on a music rendering device;
requesting, through the shared network, a second song file from a second device among the plurality of devices;
receiving, through the shared network, the second song file from the second device; and
initiating playback of the second song file on the music rendering device.

2. The method of claim 1, wherein initiating the playback of the first song file comprises transmitting the received first song file to a music rendering device.

3. The method of claim 1, further comprising receiving a registration request from at least one of the plurality of users.

4. The method of claim 1, wherein the first song is received via a streaming protocol.

5. The method of claim 1, further comprising storing a record for each of the plurality of users, the record including at least one of a number of songs played for each user and a number of minutes of songs played for each user.

6. The method of claim 1, further comprising initiating playback of a song file, wherein the song file is not received from any of the plurality of user devices.

7. The method of claim 1, wherein the requesting of the second song file is initiated before the playback of the first song file is completed.

8. The method of claim 1, further comprising:
requesting, through the shared network, a third song file from the first device;
receiving, through the shared network, at least one of metadata associated with the third song file and a portion of the third song file from the first device;
declining to initiate playback of the third song file; and
requesting, through the shared network, a fourth song file from the first device.

9. The method of claim 1, wherein initiating playback of the first song includes facilitating access for the first device to the music rendering device.

10. The method of claim 1, further comprising receiving, through the shared network, ratings information from one or more of the plurality of users, the ratings information relating to the first or second song file.

11. The method of claim 10, further comprising in response to the ratings information, cancelling the playback of the first or second song file.

12. The method of claim 1, wherein initiating playback of the first song file on the music rendering device includes broadcasting the first song file for individual reception on one or more of the plurality of user devices.

13. A method comprising:
transmitting, through a communication network, a request from a user device to a host device to join a shared network comprising a plurality of user devices;
receiving a user selection of a playlist of one or more songs, the one or more songs each associated with a respective song file stored on the user device;
receiving, through the shared network, a first request from the host device to share one song from the playlist;
identifying a first song from the playlist; and
transmitting, through the shared network, a song file associated with the identified first song to the host device for playback on a music rendering device.

14. The method of claim 13, further comprising receiving user input specifying one or more songs to include in the playlist.

15. The method of claim 13, further comprising:
receiving, through the shared network, a second request from the host device to share one song from the playlist;
identifying a second song from the playlist, the second song being different from the first song; and
transmitting, through the shared network, a song file associated with the identified second song to the host device for playback on a music rendering device.

16. The method of claim 13, further comprising:
receiving ratings information for a particular song playing on the music rendering device; and
transmitting the received ratings information to the host device.

17. The method of claim 13, further comprising transmitting mode information to the host device, the mode information including at least one of sharing only mode, listening only mode, and sharing and listening mode.

18. The method of claim 13, further comprising:
receiving user input selecting a listening only mode;
receiving, through the shared network, a second request from the host device to share one song from the playlist; and
transmitting, through the shared network, an indication declining the second request to share.

19. The method of claim 13, further comprising:
receiving user input indicating a desire to skip a current song being played on the music rendering device; and
initiating playback of one of the song files associated with one of the songs from the user selected playback.

20. The method of claim 13, further comprising:
presenting poll questions to the user;
receiving, through the shared network, a second request from the host device to share one song from the playlist;
determining if less than all of the presented poll questions have been answered; and
transmitting, through the shared network, an indication declining the second request to share when less than all of the presented poll questions have been answered.
